(19) United States
(12) Patent Application Publication
(10) Pub. No.: US 2018/0349823 A1
(43) Pub. Date: Dec. 6, 2018

(54) SYSTEMS AND METHODS FOR GENERATING AND MANAGING SERVICE APPOINTMENTS

(71) Applicant: salesforce.com, inc., San Francisco, CA (US)

(72) Inventors: Neeraj Ahuja, Fremont, CA (US); Nilesh Patel, San Rafael, CA (US); Priyank Shah, Fremont, CA (US); Rasik Phalak, Fremont, CA (US)

(73) Assignee: salesforce.com, inc., San Francisco, CA (US)

(21) Appl. No.: 15/615,021

(22) Filed: Jun. 6, 2017

(51) Int. Cl. G06Q 10/06; G06Q 30/00

(52) U.S. Cl. CPC G06Q 10/06312; G06Q 10/063112; G06Q 30/016; G06Q 10/063116; G06Q 10/063114

(57) ABSTRACT

Systems and methods are disclosed for scheduling a service appointment. A method can include analyzing attributes of a customer service request with respect to a problem area. A multi-factor scheduling analysis is performed by analyzing skill level and resource data associated with the problem area attributes for servicing the customer service request. The analysis is used for scheduling a service appointment to handle the customer service request.

### TECHNICAL FIELD

This disclosure relates to service appointments and more particularly to generating and managing service appointments.

### BACKGROUND

Customer appointment scheduling systems are used to assign service jobs to employees or contractors to handle customer service requests. Difficulty can arise when the systems attempt to structure service appointments that allow a company to achieve full potential of their resources.

For example, when a customer's issue cannot be resolved remotely, personnel is needed at the customer's location. Efficiency is lost if the proper field service team is not deployed. Efficiency is also lost if drive times are too long or excessive white space exists in their schedules. Accordingly, appointment scheduling systems need to efficiently manage work orders, maximize utilization rates, and keep customers satisfied.

### BRIEF DESCRIPTION OF THE DRAWINGS

The present invention will be understood more fully from the detailed description given below and from the accompanying drawings of various embodiments of the present invention, which, however, should not be taken to limit the present invention to the specific embodiments, but are for explanation and understanding only.

FIG. 1 is a block diagram depicting an exemplary embodiment of an on-demand multi-tenant database system.

FIG. 2 is a block diagram depicting a system for scheduling service appointments to handle customer service requests.

FIG. 3 is a block diagram depicting the scheduling system making service appointments based on multi-factor scheduling analysis.

FIG. 4 is a flow chart depicting an operational scenario for handling a single day appointment.

FIG. 5 is a block diagram depicting the scheduling system handling multiple day appointments.

FIG. 6 is a flow chart depicting an operational scenario for handling multiple day appointments.

FIG. 7 is a flow chart depicting an operational scenario using a scheduling database.

FIG. 8 is a flow chart depicting an operational scenario using a data object model.

### DETAILED DESCRIPTION

The subject matter described herein discloses apparatuses, systems, techniques and articles that generate and manage service appointments, such as for handling customer service requests. In some examples, apparatuses, systems, techniques and articles disclosed herein provide a scheduling engine for scheduling service calls. In some examples, systems and methods disclosed herein use multiple factors for scheduling service calls.

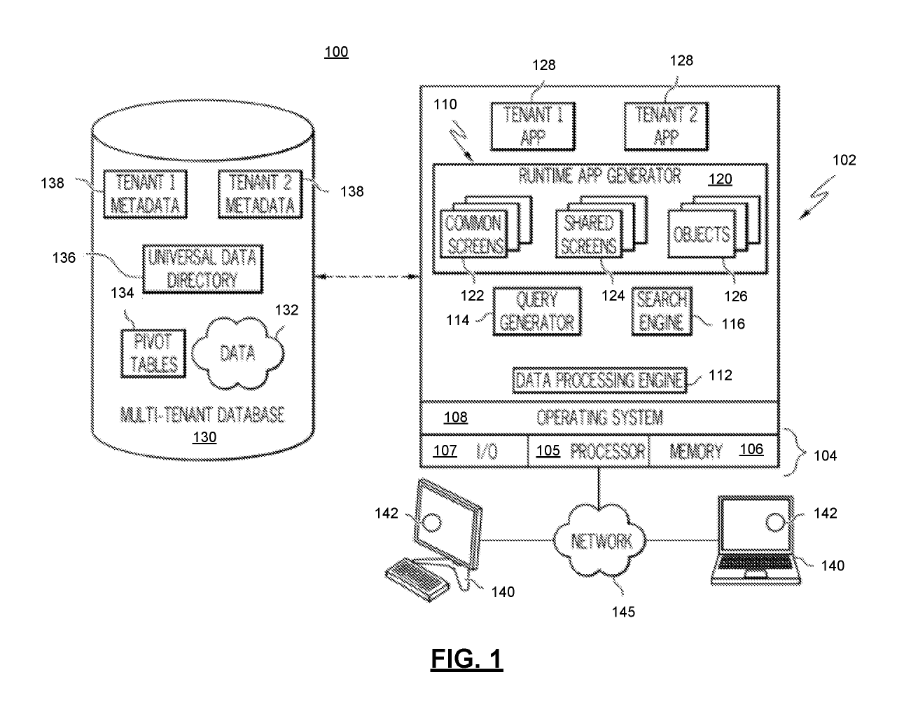

FIG. 1 and the following discussion are intended to provide a brief, general description of one non-limiting example of an example environment in which the embodiments described herein may be implemented. Those of ordinary skill in the art will appreciate that the embodiments described herein may be practiced with other computing environments.

FIG. 1 depicts an exemplary embodiment of an on-demand multi-tenant database system 100. The illustrated multi-tenant system 100 of FIG. 1 includes a server 102 that dynamically creates and supports virtual applications 128 based upon data 132 from a common database 130 that is shared between multiple tenants, alternatively referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users or entities that shares access to common subset of the data within the multi-tenant database 130. In this regard, each tenant includes one or more users associated with, assigned to, or otherwise belonging to that respective tenant. To put it another way, each respective user within the multi-tenant system 100 is associated with, assigned to, or otherwise belongs to a particular tenant of the plurality of tenants supported by the multi-tenant system 100. Tenants may represent customers, customer departments, business or legal organizations, and/or any other entities that maintain data for particular sets of users within the multi-tenant system 100 (i.e., in the multi-tenant database 130). For example, the application server 102 may be associated with one or more tenants supported by the multi-tenant system 100. Although multiple tenants may share access to the server 102 and the database 130, the particular data and services provided from the server 102 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 132 belonging to or otherwise associated with other tenants.

The multi-tenant database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128. The multi-tenant database 130 may alternatively be referred to herein as an on-demand database, in that the multi-tenant database 130 provides (or is available to provide) data at run-time to on-demand virtual applications 128 generated by the application platform 110.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or application platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request. In this manner, the query generator 114 suitably obtains requested subsets of data 132 accessible to a user and/or tenant from the database 130 as needed to populate the tables, reports or other features of the particular virtual application 128 for that user and/or tenant.

Still referring to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 126 such as “account” objects, “opportunity” objects, “contact” objects, or the like. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still with reference to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130. Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. As noted above, the virtual application 128 may contain Java, ActiveX, or other content that can be presented using conventional client software running on the client device 140; other embodiments may simply provide dynamic web or other content that can be presented and viewed by the user, as desired.

A data item, such as a knowledge article, stored by one tenant (e.g., one department in a company) may be relevant to another tenant (e.g., a different department in the same company. One way of providing a user in another tenant domain with access to the article is to store a second instance of the article in the tenant domain of the second tenant. The apparatus, systems, techniques and articles described herein provide another way of providing a user in another tenant domain with access to the article without wasting resources by storing a second copy.

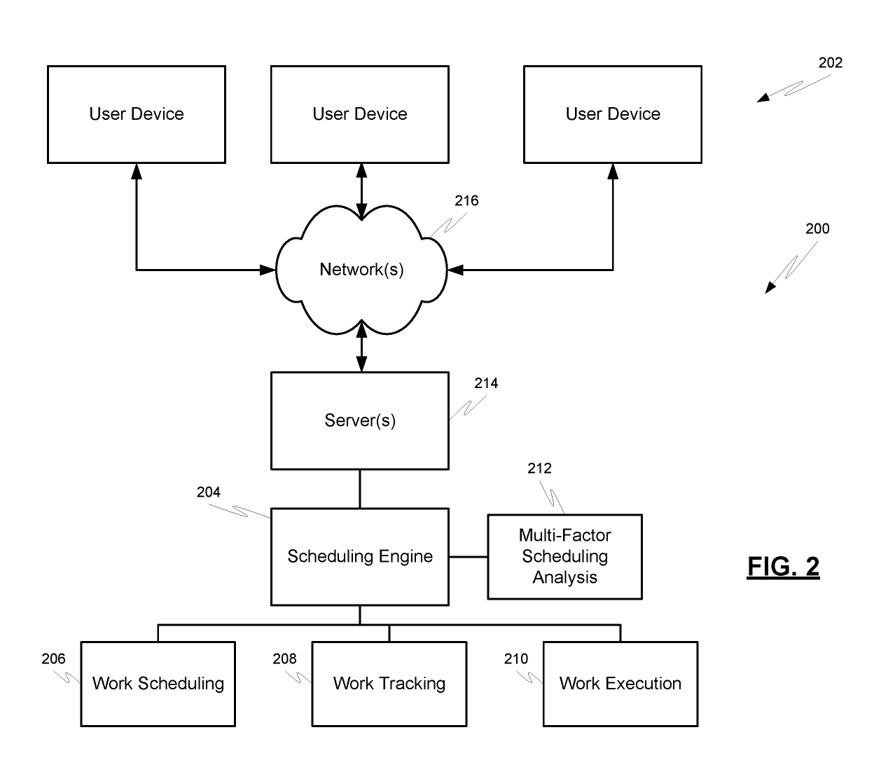

FIG. 2 depicts at 200 a system, such as but not limited to a multi-tenant system, for scheduling service appointments to handle customer service requests. The scheduling system 200 may be configured to handle many different types of customer service requests or to handle customer service requests only in a particular area. For example, the scheduling system 200 can process requests related to cable TV installations, HVAC (heating, ventilation, and air-conditioning) installations, lawn care, computer repair service, etc. Conversely, the scheduling system 200 can be configured to handle only a single area, such as cable TV installations.

Customer service requests may come from many different sources, such as from customers accessing user devices 202. The user devices 202 may be a personal computer, laptop computer or a mobile device or accessory such as a smart phone, tablet, smart watch, etc. A customer may also speak to a customer representative to discuss what service is needed. In such a scenario, the customer representative may use a user device to enter the customer service request into the scheduling system 200.

The scheduling system 200 uses a scheduling engine 204 for work scheduling 206, tracking 208, and executing 210 work orders. The scheduling engine 204 receives information about customer service requests, whether provided through the remote user devices 202 or through customer representatives over data communication network(s) 216. As depicted in FIG. 2, the scheduling engine 204 operates on one or more server(s) 214 and is connected to the data communication network(s) 216 to receive customer service request information.

The scheduling engine 204 assigns resources to handle a customer service request by analyzing attributes of the customer service request with respect to a pre-defined problem area. The scheduling engine 204 then performs a multi-factor scheduling analysis 212 by analyzing the skill-level associated with the attributes of the problem area. For example, a problem area associated with a customer service request may involve cable TV installation. The scheduling engine 204 uses a scheduling database to determine the skill level needed to handle the problem area. A different skill level may be needed for installing cable TV in a home versus installing a networked cable TV system throughout an entire office building. The scheduling database provides a mapping of problem areas with the desired skill level for use by the scheduling engine 204.

The scheduling engine 204 may also consider other factors for assigning resources to handle a customer service request. For example, the scheduling engine 204 can query the scheduling database to determine the resources that are available to handle the customer service request. Based on the multi-factor scheduling analysis the scheduling engine 204 assigns one or more resources to service the customer service request.

The data communication network(s) 214 used by the scheduling engine 204 may be any digital or other communications network capable of transmitting messages or data between devices, systems, or components. In certain embodiments, the data communication network(s) 214 includes a packet switched network that facilitates packet-based data communication, addressing, and data routing. The packet switched network could be, for example, a wide area network, the Internet, or the like. In various embodiments, the data communication network(s) 214 includes any number of public or private data connections, links or network connections supporting any number of communications protocols. The data communication network(s) 214 may include the Internet, for example, or any other network based upon TCP/IP or other conventional protocols. In various embodiments, the data communication network(s) 214 could also incorporate wireless and/or wired telephone network, such as a cellular communications network for communicating with mobile phones, personal digital assistants, and/or the like. The data communication network(s) 214 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

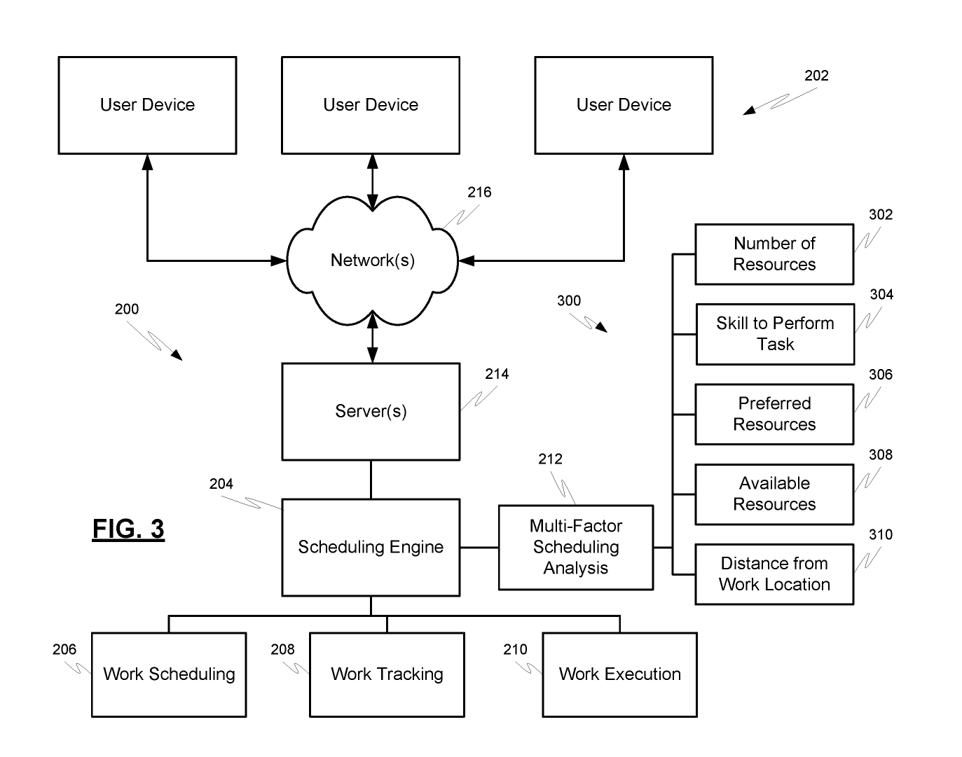

FIG. 3 depicts the scheduling system 200 performing service appointment resource assignment based on the multi-factor scheduling analysis 212. In this example, the multi-factor scheduling analysis 212 can use the following factors: number of resources 302, skill to perform a task 304, preferred resources 306, available resources 308, and distance from work location 310.

The number of resources factor 302 includes assessing whether an appointment requires a single resource or multiple resources based on the amount of work specified as an attribute of the problem area. This factor may also specify that certain types of service appointments have a minimum number of resources that are required to complete the task. As an illustration, installation of HVAC in an office building of a certain size may require at least three workers skilled in this problem area.

The skill factor 304 includes assessing which resources have the predefined skills to complete the task. The preferred resources factor 306 includes assessing whether an appointment might have a resource that is preferable to others if this resource is available for the assignment.

The available resources factor 308 includes assessing whether a resource has sufficient availability for the segment. For example, some resources may not be available because they are already scheduled during the appointment's time or they are not available to schedule because of absences (e.g., holiday, training, etc.).

The distance from work location factor 310 examines resource location travel time. More specifically, the resources' location relative to the location of the work assignment is used for optimal assignment of resources. The appointment's actual work location may make a significant difference for consecutive appointments. Second appointment resource assignment should consider the first appointment's actual work location because resources expend time in traveling from a previous site to a new location.

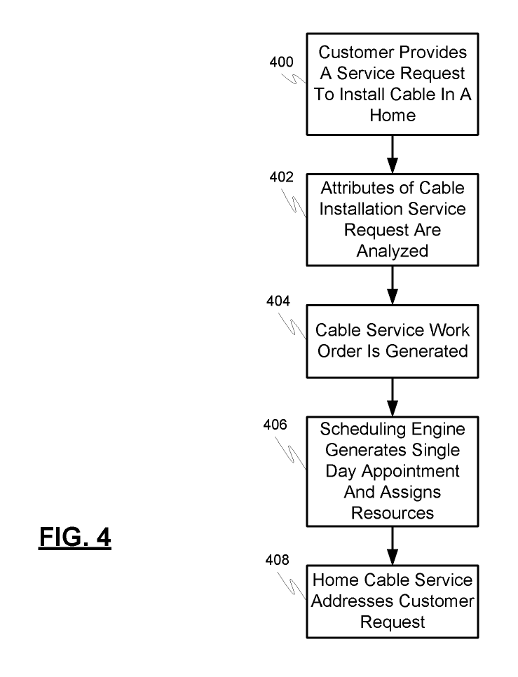

FIG. 4 depicts an operational scenario for a single day service appointment. The operational scenario involves a customer requesting installation of cable in the customer's home at process block 400. The scheduling system analyzes the attributes of the cable installation service request at process block 402. Many different types of attributes of the request can be analyzed, such as skills needed for the work assignment, preferred appointment dates and times, location of the work assignment, size dimensions of the work location, etc. Based upon the analyzed attributes, process block 404 generates the cable service work order. The work order can include in this operational scenario dates and times of the appointment, the resources involved, nature of the work to be performed, etc.

Because the work assignment in this operational scenario involves a relatively easy cable TV installation in a personal home, the scheduling engine generates a single day appointment and assigns one or more resources to fulfill the customer's request at process block 406. At process block 408, the employee(s) or contractor(s) assigned to the appointment complete the home cable service request.

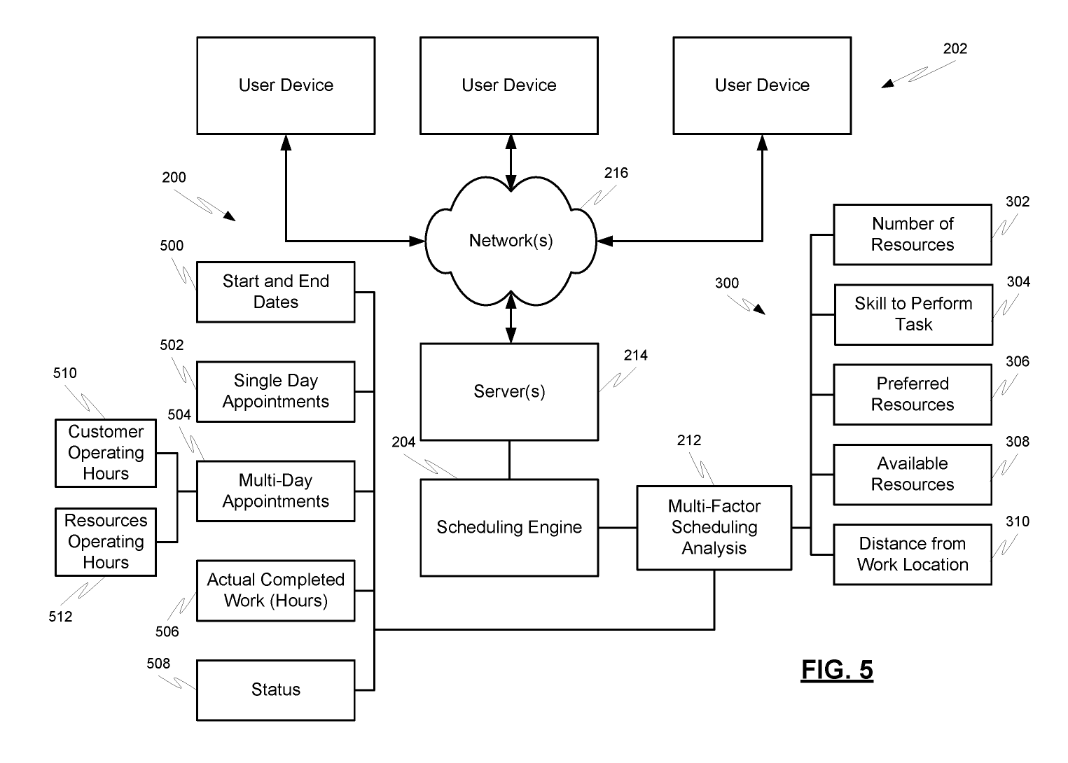

FIG. 5 depicts the scheduling system handling appointments that extend over multiple days. The scheduling engine 204 can include additional factors for the multi-factor scheduling analysis 212. These can include start and end dates 500, single day appointments 502, multi-day appointments 504, actual completed work 506, and status 512. The scheduling engine 204 can set one or more of these factors so that a service appointment could start and end within a single day 502 or extend over multiple days such as by varying the number of resources on an assignment. Typically, single day appointments 502 are scheduled for work that constitute less than a day, and multi-day appointments 504 are for work which will continue for multiple day. The multi-day appointments may be on consecutive days or include days that are not consecutive for servicing the customer's request. The multi-day appointment factor 504 includes assessing the customer's operating hours 510 as well as the resources' operating hours 512 for availability purposes.

The actual completed work factor 506 (e.g., as expressed in hours) can be calculated based on actual operating hours of resources. A status factor 508 can be used to not only indicate the status of a particular service project but also to determine which resources are already involved with unfinished projects and thus are unavailable for a new appointment. In this way, resources already assigned to projects will not be utilized in the multi-factor scheduling analysis 212 for projects that have conflicting dates.

As a project progresses, electronic notifications (e.g., email messages, text messages, etc.) can be sent to all parties to keep everyone updated as to the status of the assignment. For example, a notification can be sent to employees when a new work order has been assigned to them or to a customer to indicate that a work project has started or has been completed.

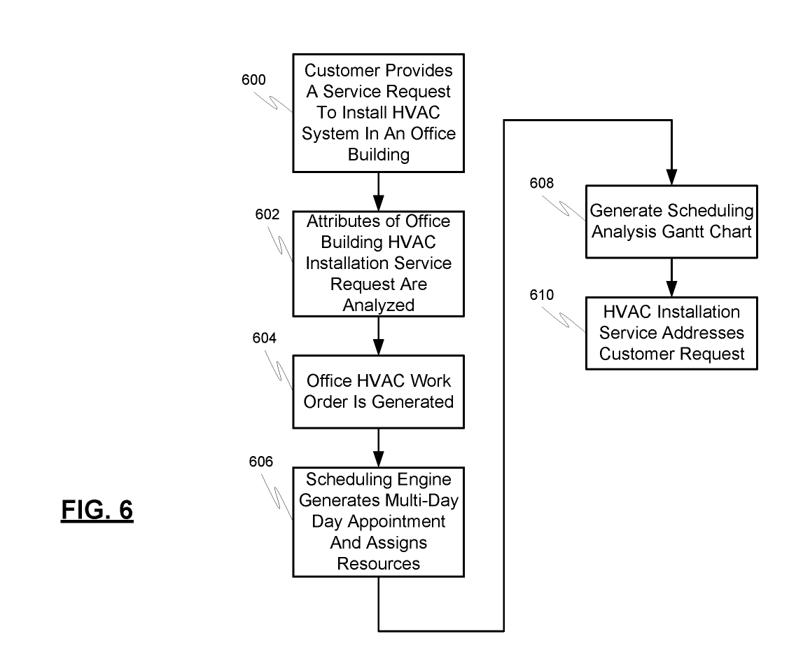

FIG. 6 depicts an operational scenario for handling a multi-day service appointment. In this operational scenario, the project is relatively substantial in that the project involves installing an HVAC (heating, ventilation, and air-conditioning) system to service an entire office building. At process block 600, the customer provides the service request for the HVAC installation. Attributes of the HVAC installation service request are analyzed (e.g., nature of the problem area, work location, etc.) so that the work order can be generated at process block 604.

The scheduling engine generates a multi-day appointment and assigns resources to fulfill the customer's request at process block 606. At process block 608, a Gantt chart is generated in order to analyze the appointment scheduling. For example, this can include the multi-day appointment being visible in the Gantt chart only for the operating hours of resources rather than whole day. At process block 610, the employee(s) or contractor(s) assigned to the appointment complete the HVAC installation request per the work order.

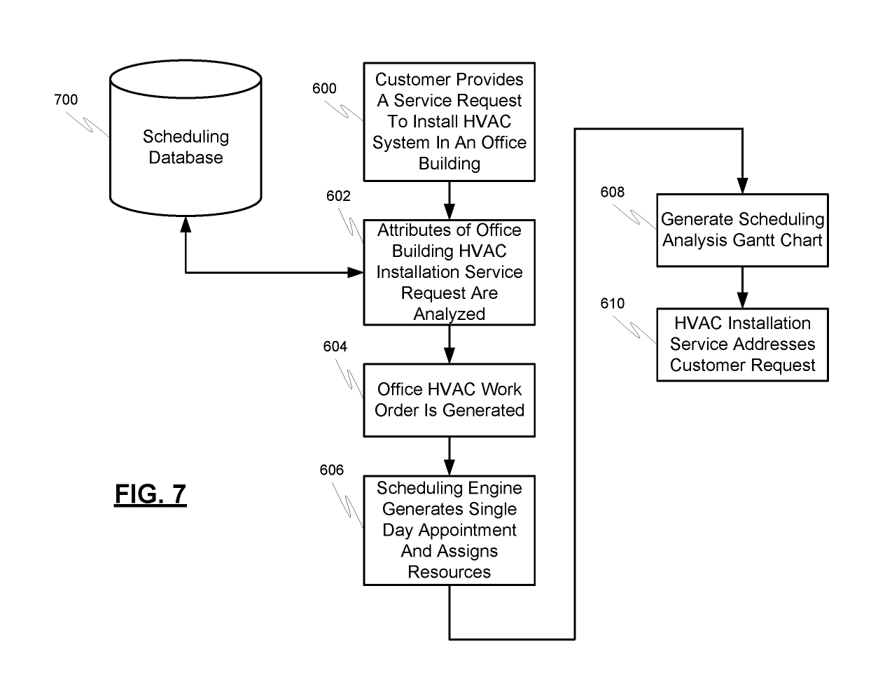

FIG. 7 depicts that the operational scenario of FIG. 6 can utilize a scheduling database 700. The scheduling database 700 can be configured to store the information needed for process block 602 to analyze the attributes of a service request. This can include information for generating the multi-factor scheduling assessment. For example, the database fields can include and interrelate skill-related fields, resource-related fields, problem-related fields, and other fields used in the scheduling, tracking, and execution of work appointments. The scheduling database can also associate service appointments with work orders, work order line items, accounts or assets, opportunities, etc.

In one embodiment, the scheduling database 700 is a relational database running on a server-based system. The database is stored on one or more volatile or non-volatile computer storage mechanisms. It is recognized that many different organizations or schemas may be utilized to interrelate one or more scheduling-related fields. For example, the skill-related fields, problem-related fields, and resource-related fields can be joined in different ways so that the resources with the proper skills can be identified to address the specific problem of the customer. In this way, the scheduling database 700 can be queried to assess the skill level and resources needed for the customer request. As another example, the scheduling database 700 can contain multiple appointments resulting from appointment rescheduling or cancellation.

The queries may be written in structured query language, natural query languages or in any other manner compatible with the scheduling database 700. In other embodiments, the scheduling database 700 may be distributed among multiple computers such that a query can operate over all data relating to the data fields used for scheduling appointments.

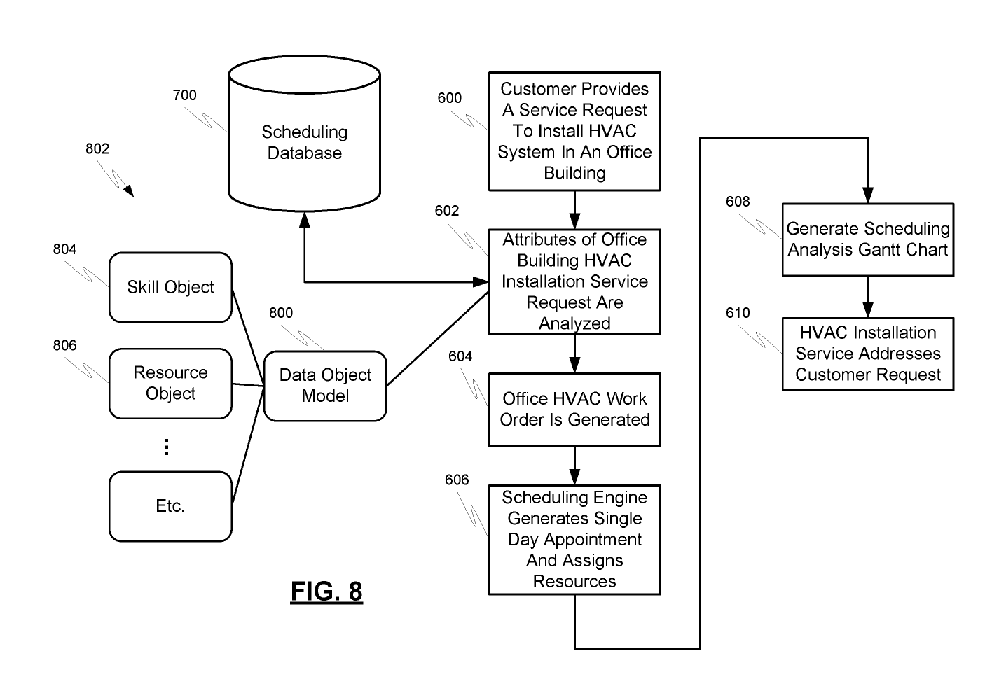

FIG. 8 depicts at 800 a data object model for use by the scheduling engine to analyze the service request attributes at process block 602. The data object model 800 can be structured in many different ways as shown at 802. In this example, the data object model 800 can include a skill object 804 for storing and manipulating skill-related data that is needed for addressing the problem associated with a customer service request. More specifically, the skill object 804 can contain methods to identify the desired skills based upon the problem area associated with the customer service request. For example, the problem area of the HVAC installation can be identified in the service request and then be used to identify the specific skill set needed to install an HVAC system in a large office building. The skill object 804 identifies the desired skill set by using the interrelationships within the scheduling database 700 that associate problem areas with the different skills needed to address the problem areas.

The data object model 800 can further include a resource object 806 that identifies resources contained in the scheduling database 700 and that have the desired skills identified by the skill object 804. To identify the proper resources, the resource object 806 uses the interrelationships within the scheduling database 700 that associate resources with their skills. The resource object 806 also examines the availability of the resources with respect to the desired dates for the service appointment. It should be understood, that other objects can be utilized, such as a customer object that identifies customer operating hours, customer location, and other information.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to object models, web pages, multi-tenancy, cloud computing, on-demand applications, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first,” “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this document. Accordingly, details of the exemplary embodiments or other limitations described above should not be read into the claims absent a clear intention to the contrary.

What is claimed:

1. A method for scheduling a service appointment, comprising:
receiving a customer service request over one or more data communication networks;
analyzing, by one or more processors, attributes of the customer service request with respect to a pre-defined problem area;
generating, by the one or more processors, a multi-factor scheduling analysis by analyzing skill level associated with the problem area attributes, skill level associated with candidate resources, and distance to location for servicing the customer service request;
using, by the one or more processors, the generated multi-factor scheduling analysis to assign one or more resources to service the customer service request; and
scheduling, by the one or more processors, the service appointment with the assigned one or more resources to handle the customer service request.

2. The method of claim 1 further comprising:
receiving the customer service request that relates to installation of equipment at a customer's location.

3. The method of claim 1 further comprising:
analyzing the attributes of the customer service request to determine skill level required for the problem area; and
analyzing the attributes of the customer service request to determine dates and times for assessing availability of the one or more resources to service the customer service request.

4. The method of claim 1 further comprising:
generating the multi-factor scheduling analysis by determining whether the customer service request requires a minimum number of resources to complete this task.

5. The method of claim 1 further comprising:
generating the multi-factor scheduling analysis by determining whether the customer service request requires a preferred resource which is preferred over other resources if the preferred resource is available for assignment.

6. The method of claim 1 further comprising:
accessing a scheduling database that contains interrelated data fields for identifying the skill level associated with the problem area and the one or more resources that are available and have the identified skill level.

7. The method of claim 6 further comprising:
accessing a scheduling database that contains multiple appointments resulting from appointment rescheduling or cancellation.

8. The method of claim 6 further comprising:
using a data object model to access the scheduling database for identifying the skill level associated with the problem area and the one or more resources that are available and have the identified skill level.

9. The method of claim 1 further comprising:
generating a multi-day appointment work order based upon amount of work to be performed by the one or more resources.

10. The method of claim 1 further comprising:
receiving the customer service request from a user device that is selected from a group that includes mobile computing platforms, mobile accessories, desktops, and tablets.

11. A system comprising a hardware processor and non-transient computer readable media coupled to the processor for scheduling a service appointment, the non-transient computer readable media comprising instructions configurable to be executed by the processor to:
receive a customer service request over one or more data communication networks;
analyze attributes of the customer service request with respect to a pre-defined problem area;
generate a multi-factor scheduling analysis by analyzing skill level associated with the problem area attributes, skill level associated with candidate resources, and distance to location for servicing the customer service request;
use the generated multi-factor scheduling analysis to assign one or more resources to service the customer service request; and
schedule the service appointment with the assigned one or more resources to handle the customer service request.

12. The system of claim 11, wherein the customer service request relates to installation of equipment at a customer's location.

13. The system of claim 11 further comprising instructions configurable to be executed by the processor to:
analyze the attributes of the customer service request to determine skill level required for the problem area; and
analyze the attributes of the customer service request to determine dates and times for assessing availability of the one or more resources to service the customer service request.

14. The system of claim 11 further comprising instructions configurable to be executed by the processor to:
generate the multi-factor scheduling analysis by determining whether the customer service request requires a minimum number of resources to complete this task.

15. The system of claim 11 further comprising instructions configurable to be executed by the processor to:
generate the multi-factor scheduling analysis by determining whether the customer service request requires a preferred resource which is preferred over other resources if the preferred resource is available for assignment.

16. The system of claim 11 further comprising:
computer readable storage medium for storing a scheduling database that contains interrelated data fields for identifying the skill level associated with the problem area and the one or more resources that are available and have the identified skill level.

17. The system of claim 16 further comprising instructions configurable to be executed by the processor to:
use a data object model to access the scheduling database for identifying the skill level associated with the problem area and the one or more resources that are available and have the identified skill level.

18. The system of claim 11 further comprising instructions configurable to be executed by the processor to:
generate a multi-day appointment work order based upon amount of work to be performed by the one or more resources.

19. The system of claim 11 further comprising instructions configurable to be executed by the processor to:
receive the customer service request from a user device that is selected from a group that includes mobile computing platforms, mobile accessories, desktops, and tablets.

20. A non-transient computer readable storage media comprising computer instructions configurable to be executed by a hardware processor to cause a database scheduling system to implement a method comprising:
receiving a customer service request over one or more data communication networks;
analyzing, by one or more processors, attributes of the customer service request with respect to a pre-defined problem area;
generating, by the one or more processors, a multi-factor scheduling analysis by analyzing skill level associated with the problem area attributes, skill level associated with candidate resources, and distance to location for servicing the customer service request;
using, by the one or more processors, the generated multi-factor scheduling analysis to assign one or more resources to service the customer service request; and
scheduling, by the one or more processors, the service appointment with the assigned one or more resources to handle the customer service request.
